(19) United States
(12) Patent Application Publication
(10) Pub. No.: US 2026/0184043 A1
(43) Pub. Date: Jul. 2, 2026

(54) METHOD OF MANUFACTURE OF COMPONENT FOR MANIPULATING AN INPUT SHOCKWAVE

(71) Applicant: FIRST LIGHT FUSION LIMITED, Yarnton, Oxfordshire (GB)

(72) Inventors: Matthew Betney, Yarnton, Oxfordshire (GB); Ian Cooke, Yarnton, Oxfordshire (GB); Oliver Hall, Yarnton, Oxfordshire (GB); Martin Harwood, Yarnton, Oxfordshire (GB); Nicholas Hawker, Yarnton, Oxfordshire (GB); David Lee, Yarnton, Oxfordshire (GB); Phil Linford, Yarnton, Oxfordshire (GB); Jonathan Skidmore, Yarnton, Oxfordshire (GB)

(21) Appl. No.: 19/099,716

(22) PCT Filed: Jul. 27, 2023
(86) PCT No.: PCT/GB2023/052000

§ 371 Date: Jan. 29, 2025

(30) Foreign Application Priority Data
Aug. 5, 2022 (GB) 2211490.4

(51) Int. Cl. B32B 15/01; B32B 1/00; B32B 3/26; B32B 7/08; B32B 38/00; B32B 38/18; G21B 3/00

(52) U.S. Cl. CPC B32B 15/01; B32B 1/00; B32B 3/266; B32B 7/08; B32B 38/0012; B32B 38/1833; B32B 2038/0016; B32B 2038/0076; B32B 2250/42; G21B 3/008

(57) ABSTRACT

A method of manufacturing a component for manipulating an input shockwave comprises forming a plurality of plates, each plate defining a sub-cavity, at least partially filling one or more of the sub-cavities with one or more cavity fill materials, and stacking the plurality of plates to form a component, such that the sub-cavities are at least partially aligned and the sub-cavities combine to define a layered component cavity containing the one or more cavity fill materials.

### CROSS-REFERENCE TO RELATED APPLICATIONS

This application is a 35 U.S.C. § 371 national phase filing of International Application No. PCT/GB2023/052000 filed on Jul. 27, 2023, and claims the benefit of United Kingdom Patent Application No. 2211490.4 filed on Aug. 5, 2022, wherein the entire disclosures of the foregoing applications are hereby incorporated by reference herein.

### TECHNICAL FIELD

This invention relates to a method of manufacture of a component for manipulating an input shockwave, in particular to a method of manufacture of components to be used in methods and apparatuses for producing high localised concentrations of energy.

### BACKGROUND

It has been shown in WO 2011/138622 that an interaction between a shockwave in a non-gaseous medium and a gaseous medium can generate a high speed transverse jet of the non-gaseous medium that moves through the gaseous medium. This results in the jet impacting on and trapping a volume of the gaseous medium, e.g. against a target, which gives rise to an intense concentration of energy within the gas.

The present invention aims to provide a method of manufacture of components for use in alternative techniques for producing localised energy concentrations.

### SUMMARY

When viewed from a first aspect, the invention provides a method of manufacturing a component for manipulating an input shockwave, the method comprising:
forming a plurality of plates, each plate defining a sub-cavity;
at least partially filling one or more of the sub-cavities with one or more cavity fill materials; and
stacking the plurality of plates to form a component, such that the sub-cavities are at least partially aligned and the sub-cavities combine to define a layered component cavity containing the one or more cavity fill materials.

The invention thus provides a method of manufacturing a component that manipulates a shockwave, when the shockwave is incident upon the component.

The component cavity preferably comprises (defines) an input (e.g. aperture) arranged to receive the (input) shockwave that is incident upon the input of the cavity. The component cavity is arranged (e.g. shaped) to manipulate the shockwave as it passes through the component cavity. The component cavity preferably comprises (defines) an output (e.g. aperture) arranged to output the manipulated shockwave.

The plates are formed from (comprise, e.g. consist of) a first material. One or more of the sub-cavities contain (e.g. are at least partially filled with) a second material, which is the cavity fill material. Thus the (shape of the) cavity is defined by the (e.g. internal walls of the) plates (formed from the first material) and the cavity fill material is located within the volume of the cavity.

Thus it will be seen that the component can be used to manipulate (e.g. modify the shape and/or intensity of) an input shockwave, owing to the (e.g. shape of the) cavity and the difference in shock-impedance of the first and second materials. As such, the shockwave transmitted from the output of the cavity may have a greater (e.g. energy) intensity than the input shockwave received at the input of the cavity.

The method comprises filling (e.g. partially filling or completely filling the volume defined by) one or more of (e.g. all of or a subset of) the sub-cavities with one or more (e.g. a single, or a plurality of different) cavity fill materials. Preferably the step of filling one or more of the sub-cavities with one or more cavity fill materials is performed before the step of stacking the plurality of plates to form the component.

The method comprises stacking (e.g. arranging in parallel) the plurality of plates to form a component such that the sub-cavities are at least partially aligned (e.g. overlapping) and combine to define a layered component cavity (e.g. an overall cavity made up of layers, each layer being defined by a sub-cavity) containing the one or more cavity fill materials. Preferably the step of stacking the plurality of plates to form the component is performed after the step of filling one or more of the sub-cavities with one or more cavity fill materials.

A component having a layered component cavity could be formed by forming a unitary body, milling the body to form the cavity, and then fitting the layers into the cavity. However, for components having small dimensions (e.g. on the mm scale or less), it is difficult to form a component in this way such that the tolerances between the layers themselves, and between the layers and the cavity wall, are acceptable. Since small imperfections in the component could significantly influence the way the component manipulates (e.g. modifies the shape and/or intensity of) an input shockwave, these imperfections are undesirable.

Manufacturing and assembling the component from a stack of discrete plates, helps to allow a layered component cavity to be formed with greater ease and manufacturing accuracy. Further, the ability to disassemble the component is helpful for quality assurance and testing purposes.

In embodiments, one or more of (e.g. all of, or a subset of) the plurality of plates are formed from (comprise, e.g. consist of) a high density material (e.g. a material having a high shock-impedance, such that the material substantially reflects input shockwaves).

In embodiments, one or more of the sub-cavities extends through the entire depth of the respective plate (e.g. from one surface of the plate to the opposite surface of the plate). In embodiments, one or more of the sub-cavities does not extend through the entire depth of the respective plate (e.g. the sub-cavity is formed as a recess or indent in the respective plate).

In embodiments, one or more of (e.g. all of, or a subset of) the plurality of plates are formed from (comprise, e.g. consist of) a (e.g. transition) metal.

In embodiments one or more of (e.g. all of, or a subset of) the plurality of plates are formed from (comprise, e.g. consist of) a heavy metal, e.g. tantalum, tungsten, copper, steel or platinum.

In embodiments, the or each cavity fill material has a lower density (e.g. a lower shock-impedance) than one or more (e.g. all) of the plurality of plates. Thus the shape and/or intensity of an input shockwave may be manipulated by the component cavity, since the shockwave may be reflected longitudinally from the boundaries between the sub-cavities and/or the plates, and also transversely from the cavity walls (at the edge of the sub-cavities).

In embodiments, the method comprises filling (e.g. partially filling or totally filling the volume defined by) one or more (e.g. all, or a subset) of the sub-cavities with a plastic material.

The sub-cavities may be filled using any suitable manufacturing method, such as additive manufacturing or injection moulding.

In embodiments, the method comprises filling (e.g. partially filling or totally filling the volume defined by) one or more (e.g. all, or a subset) of the sub-cavities with a pourable material (e.g. plastic in liquid form), and then, e.g., curing (e.g. setting) the pourable material. In embodiments, curing the pourable material may comprise exposing the pourable material to UV light. In embodiments, curing the pourable material may comprise exposing the pourable material to heat (e.g. from an oven, or from a heat gun).

Filling the one or more cavities with pourable material helps the cavity-fill material to conform exactly to the shape of the sub-cavity. Further, by forming the component in layers, and filling the one or more sub-cavities individually helps to alleviate difficulties associated with deep layers of pourable material, such as the formation of air bubbles during pouring, or UV light not penetrating through the entire depth of the pourable material such that the pourable material is unevenly cured.

In embodiments the one or more (e.g. all of the, or a subset of the) sub-cavities are over filled (e.g. the volume of cavity fill material exceeds the volume of the sub-cavity). Thus, preferably the method comprises over-filling the one or more sub-cavities. Preferably the method comprises milling back (e.g. filing back, sanding back, shaving back, removing with a laser) the surfaces of the one or more of the plurality of plates to remove excess material (e.g. to remove excess (sub-) cavity fill material, and excess plate material) and smooth (e.g. remove imperfections on) the surfaces of the plates.

In embodiments, forming the plates may comprise forming the plates to be slightly thicker (in the dimension perpendicular to their plane) than the required final dimension. Preferably the (first material of the) plates and, e.g., the excess cavity fill material is milled back together. This helps to improve the quality of the surface finish. Since the cavity fill material and the material of the plate itself are milled back together, this helps to avoid a step at the edge of the sub-cavity.

The pourable material may comprise any suitable material, but in embodiments the pourable material comprises a pourable plastic material, e.g. polymethyl methacrylate (PMMA) or epoxy resin.

The invention also extends to a component manufactured according to the method outlined herein. It will be appreciated that, where applicable, any (e.g. optional and preferable) features outlined herein with respect to the method apply equally to the component, and vice versa.

In embodiments, the component cavity comprises an input (e.g. aperture) for receiving (e.g. designed to receive) the (input) shockwave, and an output (e.g. aperture) for outputting (e.g. designed to output) the shockwave, and wherein the component cavity is shaped (e.g. the sub-cavities are shaped and arranged with respect to one another) such that the cross sectional area of the input is greater than the (e.g. corresponding) cross sectional area of the output.

The cross sectional area of the input and/or the output may be defined in a plane substantially perpendicular to a direction between the input and the output, e.g. such that the cross sectional area of the input is substantially parallel to the cross sectional area of the output. The direction between the input and the output may be substantially parallel to the direction in which the input shockwave is arranged to be propagated to be incident upon the component (e.g. in embodiments of the invention).

In embodiments, each sub-cavity has an input (e.g. aperture) for receiving the shockwave, and an output for outputting the shockwave, and wherein one or more of the sub-cavities is shaped such that the cross sectional area of the input is greater than the cross sectional area of the output.

The plates may comprise (e.g. (internal) walls having) any suitable and desired shape to define the sub-cavities. In embodiments, one or more (e.g. all, or a subset) of the sub-cavities comprises a frustum, e.g. one or more plates are shaped to define a frustum shaped sub-cavity.

The frustum may comprise any suitable and desired type of frustum. In embodiments, one or more sub-cavity comprises a conic frustum. Thus, preferably the one or more (e.g. all, or a subset) of the sub-cavities is rotationally symmetric about an axis through the sub-cavity. Preferably the axis of the plate or sub-cavity is parallel to the direction between the input and the output.

In embodiments, one or more (cross sections and/or walls of the) sub-cavities comprise two or more sections that are at different respective angles to the axis of the sub-cavity (e.g. the axis about which the sub-cavity is rotationally symmetric, e.g. the axis being parallel to the direction between the input and the output). Thus, for example, the one or more sub-cavities may comprise two or more frustums (e.g. sharing a common axis), wherein the two or more frustums have side walls having different respective angles to the axis of the sub-cavity. Providing different angles may help to manipulate the input shockwave in a particular manner, e.g. to accelerate the input shockwave from the input to the output.

In embodiments in which one or more sub-cavities have three or more frustum sections, each section may be at a different angle to each of the other sections; however, two or more of the sections may be at the same angle, with one or more intermediate sections of the sub-cavity at a different angle.

In embodiments, instead of or in addition to one or more sub-cavities having one or more straight-sided sections (in cross section), the one or more sub-cavities may have a cross section having one or more sections having curved walls. For example, the one or more sub-cavities may comprise a flared (e.g. conic) frustum wherein the sub-cavity walls are (e.g. elliptically) curved. These types of shapes may help to provide greater uniformity of the shock front and of the shock shape at the output.

In embodiments, two or more of the plurality of plates comprise one or more alignment holes (e.g. through holes) configured (e.g. having a size and shape designed) to receive an alignment member (such as a pin), the method comprising aligning the two or more plates by placing one or more alignment members through the one or more alignment holes.

In embodiments, two or more of the plurality of plates comprise one or more fastening holes (e.g. through holes) configured (e.g. having a size and shape designed) to receive a fastening member (such as a rod or bolt), the method comprising securing the two or more plates together by placing one or more fastening members through the one or more fastening holes. Fastening two or more plates together using a fastening member passing through fastening holes in the plates helps to secure the plates together, while also helping to maintain the alignment of the plates with respect to one another.

In alternative embodiments, the plurality of plates may be fastened together in other ways, such as clamping, or using an adhesive.

The plurality of plates could have any suitable and desired thickness (the dimension perpendicular to the plane in which the plates extend and are parallel to each other). For example, each of the plurality of plates has the same thickness. In embodiments, the plurality of plates (e.g. each) have different thicknesses.

In embodiments, the thickness of the plurality of plates (e.g. the plates defining a sub-cavity) decreases (e.g. progressively) from the input to the output

Each (e.g. every) plate forming the component may define a sub-cavity. However, in embodiments, the plurality of plates (each defining a sub-cavity) is a plurality of first plates, and the method further comprises forming one or more second plates which do not comprise (e.g. define) a sub-cavity, and stacking (e.g. arranging in parallel) the second plates with the first plates.

In embodiments, the second plates are formed from (comprise, e.g. consist of) the same material (e.g. a heavy metal such as tantalum, platinum, copper, steel, or tungsten) as the first plates.

In embodiments, the plurality of first plates and the one or more second plates are stacked such that the plates alternate between first plates and second plates. e.g. (each of one or more of) the first plate(s) is adjacent (sandwiched between) two second plates and/or (each of one or more of) the second plate(s) is adjacent (sandwiched between) two first plates. This results in a component cavity which contains multiple parallel layers, alternating between cavity-fill material layers, and second plate material layers.

Providing multiple parallel layers within the component cavity helps to superimpose components of the input shockwave that are reflected from the boundaries between the parallel layers. This helps to amplify the intensity of the shockwave between the input and the output of the component cavity.

Although, in such embodiments, each sub-cavity is separated from the adjacent sub-cavities by a second plate, it will be understood that the sub-cavities still combine to form a combined component cavity, since the effect of the component cavity on an input shockwave may still be the same as it would be if the body was formed as a single piece defining a unitary cavity, and that cavity was then filled with a plurality of parallel layers (e.g. comprising cavity-fill material layers and second plate material layers).

The one or more second plates could have any suitable and desired thickness (the dimension perpendicular to the plane in which the second plates extend and are parallel with the first plates). For example, each of the second plates has the same thickness. In embodiments, the one or more second plates (e.g. each) have different thicknesses. Preferably one or more (e.g. all) of the at least one second layer (e.g. each) has a thickness that is greater than the thickness of (e.g. each of) one or more (e.g. all) of the at least one first layer.

In embodiments in which the plurality of parallel layers comprises a plurality of first layers and/or a plurality of second layers, each of the plurality of first layers may have the same thickness and/or each of the plurality of second layers may have the same thickness, preferably with the plurality of second layers (e.g. each) having a thickness greater than the thickness of (e.g. each of) the plurality of first layers. In embodiments, the thickness of the plurality of second plates decreases (e.g. progressively) from the input to the output.

The component may have any suitable and desired dimensions and the dimensions will be determined by the specific application of the component. In one embodiment the (e.g. layered component cavity of the) component has a thickness, diameter and/or maximum dimension between 0.1 mm and 100 mm, e.g. between 1 mm and 50 mm, e.g. between 2 mm and 10 mm, e.g. approximately 3 mm, 5 mm or 8 mm.

It will be understood that where used herein, the term “shock-impedance” is intended to mean “the pressure which must be applied to a medium in order to impart a unit particle velocity to some of the medium” (Henderson, ‘On the refraction of shock waves’, Journal of Fluid Mechanics, Volume 198, January 1989, pages 365-386). This is equal to the product of the shock speed and the density of the un-shocked material.

It will be understood that the input shockwave may be formed outside of the (e.g. element of the) component and propagate into the component, but may additionally or alternatively be generated in the component, for example by the (e.g. element of the) component being struck (e.g. by a projectile). Both alternatives are covered by the wording “input shockwave”.

Embodiments of the component may be suitable for manipulating (e.g. amplifying) shockwaves (e.g. to generate localised energy concentrations), e.g. for the purpose of generating conditions suitable for nuclear fusion. However, the component is not limited to this, and may be used for other applications, for example, the testing of safety equipment such as crash helmets. In one example, the component may be used to provide an impact shockwave for testing the impact force dampening and defusing structure shown in U.S. Pat. No. 10,653,193 B2.

### BRIEF DESCRIPTION OF DRAWINGS

Certain embodiments of the invention will now be described, by way of example only, with reference to the accompanying drawings, in which:

FIG. 1 shows a cut-through perspective view of a component, for manipulating an input shockwave, which has not been manufactured using a method in accordance with the invention;

FIG. 2 shows a cut-through perspective view of a component, for manipulating an input shockwave, which has been manufactured using a method in accordance with an embodiment of the invention;

FIG. 3 shows a system incorporating the component of FIG. 2;

FIG. 4 shows a cut-through perspective view of a single layer of the component of FIG. 2;

FIG. 5 shows a cut-through perspective view of another single layer of the component of FIG. 2;

FIG. 6 shows the plates of the component of FIG. 2 in exploded view;

FIG. 7 shows a flow chart illustrating a method in accordance with one embodiment of the invention;

FIG. 8 shows a variant of the component of FIG. 2; and

FIG. 9 shows another variant of the component of FIG. 2.

### DETAILED DESCRIPTION

Methods of manufacture of components for manipulating (e.g. producing localised energy concentrations from) an input shockwave will now be described.

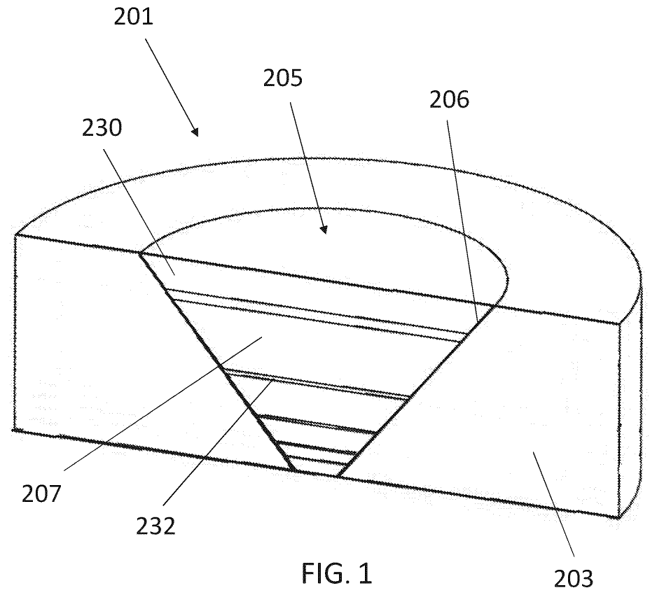

FIG. 1 shows a cut-through perspective view of a component 201 for producing localised energy concentrations from an input shockwave. The component 201 comprises a body 203 which defines a hollow conic frustum shaped component cavity 205 having a cavity wall 206. The body 203 is formed of a material having a high shock-impedance. The cavity 205 contains a cavity fill material 207 having a low shock-impedance. The cavity fill material 207 has a lower shock-impedance than that of the body 203. Within the cavity 205, a plurality of parallel high shock-impedance layers 232 are provided. The plurality of high shock-impedance layers 232 separate the cavity fill material 207 into a plurality of low shock-impedance layers 230.

The body 203 may be formed of tantalum, but the body could be formed from any suitable material, e.g. any other suitable (heavy) metal such as platinum, copper, steel, or tungsten.

In an exemplary embodiment, the cavity fill material 207 is polymethyl methacrylate (PMMA), but the cavity fill material 207 could be any suitable material.

The component 1 could be formed by milling the body 203 to form the cavity 205, and then fitting the low shock-impedance layers 230 and the high shock-impedance layers 232 into the cavity 205. However, due to the small dimensions (e.g. on the mm scale or less), it is difficult to form the component 201 in this way such that the tolerances between the layers themselves, and between the layers and the cavity wall 206, are acceptable. Further, placing the high shock-impedance layers into position is difficult without them becoming deformed, or breaking. Since small imperfections in the component 201 could significantly influence the way the component manipulates an input shockwave, these imperfections are undesirable.

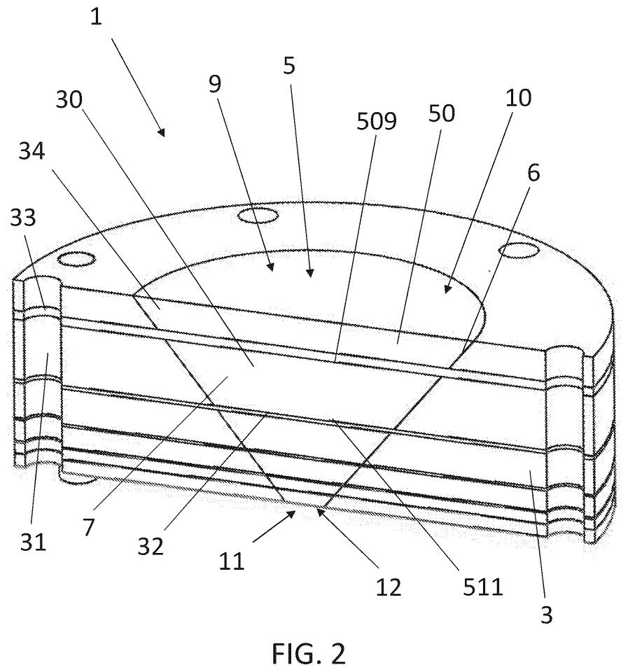

FIG. 2 shows a cut-through perspective view of a component 1 which is substantially similar to the component 1 shown in FIG. 1, but is formed of layers. Therefore, in accordance with embodiments of the invention, the component is not formed as a body with a cavity, and then filled with layers (e.g. like the component 201 shown in FIG. 1). Rather, the component is manufactured and assembled as a stack of discrete layers, which when combined, form substantially the same cavity as shown in FIG. 1, but with greater manufacturing accuracy.

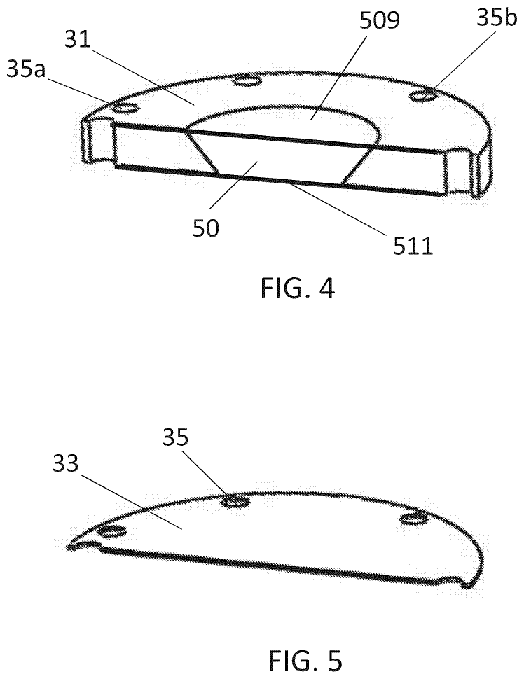

In the embodiment of FIG. 2, the low shock-impedance layers 30 are formed by sub-cavities defined by first plates 31, and the high shock-impedance layers 32 are formed as second plates 32. Both the first plates 31 and second plates 32 span the cross sectional area of the component 1, but the first plates 31 each define a sub-cavity 50, whilst the second plates 32 are solid. The body 3 itself is therefore formed of parallel layers. The component cavity 5 has an input 9 which is configured to receive a shockwave, and an output 11 which is configured to output the shockwave after the shockwave has propagated through the component 1. The cross sectional area of the input 9 is greater than that of the output 11. Similarly, as can be seen from FIG. 4, each sub-cavity has an input 509 and an output 511, and the cross sectional area of the input 509 of each sub-cavity 50 is greater than the cross-sectional area of the output 511 of that sub-cavity 50. In the illustrated embodiment, each sub-cavity 50 is shaped as a conic frustum.

The component 1 itself has an input face 10 which is proximal to the input 9 of the cavity 5, and an output face 12 which is proximal to the output 11 of the cavity 5.

The cavity 5 is filled with low shock-impedance layers 30 which are formed from the low shock-impedance cavity fill material 7 (PMMA in the illustrated embodiment), and high shock-impedance layers 32 formed from the high shock-impedance material (tantalum in the illustrated embodiment) plates. The high shock-impedance layers 32 are formed of a material having a higher shock-impedance than the material forming the low shock-impedance layers 30.

Although, in the illustrated embodiment, each sub-cavity 50 is separated from the adjacent sub-cavities 50 by a second plate 33, it will be understood that the sub-cavities 50 still combine to form a combined component cavity 5, since the effect of the component cavity 5 on an input shockwave is still the same as it would be if the body was formed as a single piece defining a unitary cavity, and that cavity was then filled with a plurality of parallel layers, alternating between high shock-impedance layers and low shock-impedance layers (e.g. as in FIG. 1).

The parallel layers alternate from low shock-impedance layers 30 to high shock-impedance layers 32 from one layer to the next. In the illustrated embodiment, an input layer 34 which forms the input face 10 of the component 1 is a low shock-impedance layer 30. This is because an input face 10 formed from a high shock-impedance layer 32 would result in a larger portion of the shockwave being reflected by the input face 10, and hence not transmitted into the component 1. However, the alternative is envisaged.

In the illustrated embodiment, the high shock-impedance layers 32 and the low shock-impedance layers 30 have thicknesses that decrease progressively from the input face 10 to the output face 12, with the exception of the input layer 34. It will be understood that although the thickness may vary between layers, each individual layer has a uniform thickness across its width.

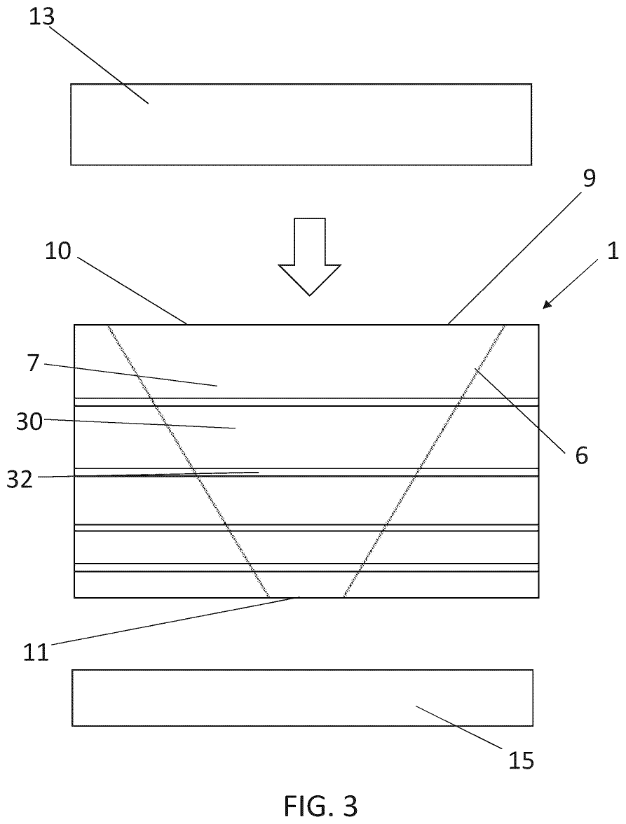

Operation of the component 1 will now be explained with reference to FIG. 3. The input 9 is configured to receive a shockwave. In the embodiment shown in FIG. 3, this shockwave is generated by striking the input face 10 of the component 1 with a disk shaped projectile 13. This strike generates a planar shockwave in the component 1 which is focussed by the component 1 onto a target 15, creating a localised concentration of energy at the location of the target 15.

On input into the cavity 5, the input shock reflects from the cavity walls 6 as an irregular shock reflection (Mach reflection) that propagates in from the cavity walls 6, eventually overlapping on the central axis of the cavity 5. The overlap of this radially-symmetric wave on the central axis creates a high pressure point within the cavity fill material 7, which expands and interacts with the impinging Mach reflection, leading to the generation of an axial, quasi-planar Mach stem that propagates towards the output 11 of the cavity 5.

The layers 30, 32 are arranged such that shockwaves generated at the input face 10 of the component 1 reverberate within the stack of layers, as a result of reflections from the high shock-impedance layers 32, leading to regions of constructive and destructive interference as shock waves pass over one another. When a shock passes from a low shock-impedance layer 130 into a high shock-impedance layer 132, a portion of the shock is transmitted into the high shock-impedance layer 132 whilst a portion is reflected back into the low shock-impedance layer 130.

The portion in the low shock-impedance layer 130 speeds up since it is now travelling through pre-shocked material, the shock portion then reflects from the boundary at the input of the low shock-impedance layer, and since it has been sped up, the reflected portion eventually catches up with the portion of the shock that was initially transmitted into the high shock-impedance layer 132. Through the arrangement of the low and high shock-impedance layers 30, 32, the component 1 can be arranged such that a plurality of shock features superimpose on the output face 12 of the component 1, leading to a short-lived high shock pressure state that can be passed into a target adjacent to the component output 12.

The combination of the focusing shape of the frustum shaped cavity 5 with the parallel layers 30, 32 leads to a component design which has been shown to be capable of greatly increasing shock pressures on output, relative to either of the features individually. Shock reflections from the walls of the cavity 5 interact with axial shock reflections from the high shock-impedance layers 32, creating regions of locally high thermodynamic pressure. These high-pressure regions expand and interact with further shock reflections downstream in the component 1, creating regions with yet-higher shock pressure, that eventually pass through to the output 11 of the cavity 5. Through configuration of the parallel layer materials and thicknesses, as well as the shape of the cavity 5, it is possible to control the pressure of the shock at the output 11, as well as the uniformity of the shock state and shape. It will be understood that although the thickness may vary between layers, each Individual layer has a uniform thickness across its width.

In addition to generating the conditions for local shock superposition and constructive interference, the parallel layers 30, 32 also act to effectively slow the shock transit time through the component 1. This allows energy from more of the projectile 13 to be harvested and combined into a single shock state upon emergence from the component 1.

Simulations and experiments have shown that a pressure multiplication factor of at least 15 is achievable for an input-radius/exit-radius ratio of ˜9 for a component design in line with the embodiment of FIG. 1. For example, in simulations, with an input shockwave having a pressure of 83 GPa, an output pressure of 1240 GPa was achieved.

FIG. 4 shows a cut-through perspective view of a single first plate 31, e.g. that may be used in the component 1 shown in FIGS. 2 and 3. The first plate 31 is a flat disk, defining a frusto-conical sub-cavity 50 at its centre. The sub-cavity 50 passes through the depth of the plate 31 such that the input 509 and output 511 of the sub-cavity are open before the first plate 31 is stacked. The first plate 31 comprises a plurality of holes 35 which are near to the circumferential edge of the first plate 31. The longitudinal axis of the holes 35 is parallel to the longitudinal axis of the sub-cavity 50, and perpendicular to the plane of the first plate 31. Each of the holes 35 is either an alignment hole 35a which is configured to receive an alignment member such as a pin, or a fastening hole 35b which is configured to receive a fastening member such as a bolt.

FIG. 5 shows a cut through perspective view of a single second plate 33, e.g. that may be used in the component 1 shown in FIGS. 2 and 3. The second plate 33 is a solid flat disk. Like the first plate 31 shown in FIG. 4, the second plate 33 comprises a plurality of holes 35 which are near to the circumferential edge of the second plate 33. The longitudinal axis of the holes 35 is perpendicular to the plane of the second plate 33. The holes 35 in the first plates 31 and second plates 33 are configured to align such that a fastening member such as a bolt, or alignment member such as a pin can be inserted through the holes to align and secure the first and second plates 31, 33, together.

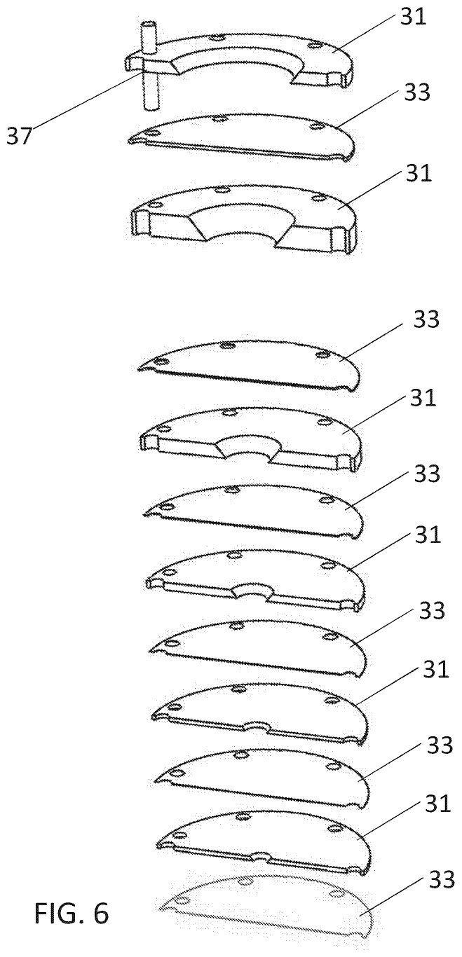

FIG. 6 shows an exploded view of the first and second plates 31, 33 which are arranged to be stacked, e.g. to form the component 1 shown in FIGS. 2 and 3. In the view of FIG. 5, the sub-cavities 50 are unfilled. As can be seen from FIG. 5 the first and second plates 31, 33 are stacked in an arrangement alternating between first plates 31 and second plates 33 from one plate to the next. Further, the first and second plates 31, 33 are aligned such that the longitudinal axis around which each plate is rotationally symmetrical is coaxial with the longitudinal axis of the other plates. Further, the alignment holes 35a are aligned to allow an alignment member 37 to be inserted. Only a single alignment member is shown in FIG. 5, but it will be understood that an alignment member will be provided for each set of alignment holes 35a. The alignment members 37 maintain the alignment of the first and second plates 31, 33 in the formed component.

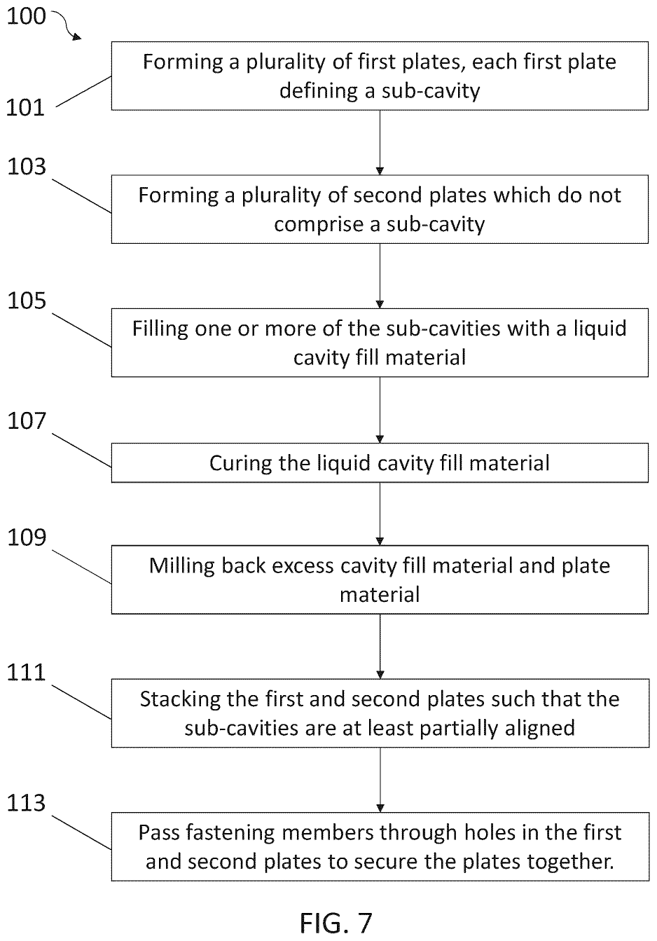

The method 100 of manufacture of the component 1 will now be described in detail with reference to the flow chart of FIG. 7. At step 101, the plurality of first plates 31 are formed. The first plates 31 may be formed in any known way. For example, the first plates 31 may be cast. Alternatively, each first plate 31 may be cut from a larger sheet of material, and milled to form the sub-cavity 50. The holes 35 may be formed in any known way, for example by drilling.

At step 103, the plurality of second plates 33 are formed. The second plates 33 may be formed in any known way. For example, the second plates 33 may be cast. Alternatively, each second plate 33 may be cut from a larger sheet of material. The holes 35 may be formed in any known way, for example by drilling.

At step 105, one or more of the sub-cavities 50 are filled with a liquid cavity fill material 7. The cavity fill material 7 may be a curable liquid such as a curable plastic, or a glue. The one or more sub-cavities 50 are over-filled. Then at step 107, the liquid cavity fill material is cured. The cavity fill material 7 may be cured in any known way, depending on the cavity fill material 7. For example, the cavity fill material 7 may be cured using UV light, or using heat. In embodiments where the cavity fill material 76 is epoxy resin, the cavity fill material 7 is cured using UV light.

It will be understood that in embodiments, the sub-cavities 50 may be filled in other suitable ways. For example, the cavity fill material 7 could be applied using injection moulding or additive manufacturing.

At step 109, excess cavity fill material 7 and also excess material of the first plate 31 itself is milled back. When the first plates 31 are formed, they are formed to be slightly thicker than the required final dimension so that the first plates 31, and the excess cavity fill material 7 can be milled back together. This helps to improve the quality of the surface finish. Since the cavity fill material 7, and the material of the plate itself are milled back together, no step exists at the edge of the sub-cavity 50.

At step 111, once all of the sub-cavities to be filled have been filled, the first and second plates 31, 33 are arranged in parallel, as shown in FIG. 6, and stacked such that the plurality of sub-cavities at least partially align to form a combined component cavity 5. The alignment of the plates may be assisted by the insertion of alignment members 37 into alignment holes 35a.

Finally, at step 113, fastening members, bolts in the illustrated embodiment, are passed through the fastening holes 35b to secure the layers together. The fastening members ensure that the alignment between the first and second plates 31, 33 is correct.

It will be understood that the description provided above, is framed in terms of manufacturing components 1, individually. The skilled person will understand that for mass production, first and second plates 31, 33 for several components 1 could be made at once. For example, a single sheet may be formed for each layer, the sheets corresponding to first plates 31 having a plurality of milled sub-cavities 50. These sub-cavities 50 may be filled, the sheets milled, and the sheets stacked and fastened together such that a completed element is formed comprising a plurality of individual components 1. The components 1 themselves may then be cut from the overall element, for example by laser cutting.

It will be understood that the component shown in FIG. 2 is purely exemplary, and that variants of the component 1 of FIG. 2 may also be manufactured using a method of manufacture according to the present invention.

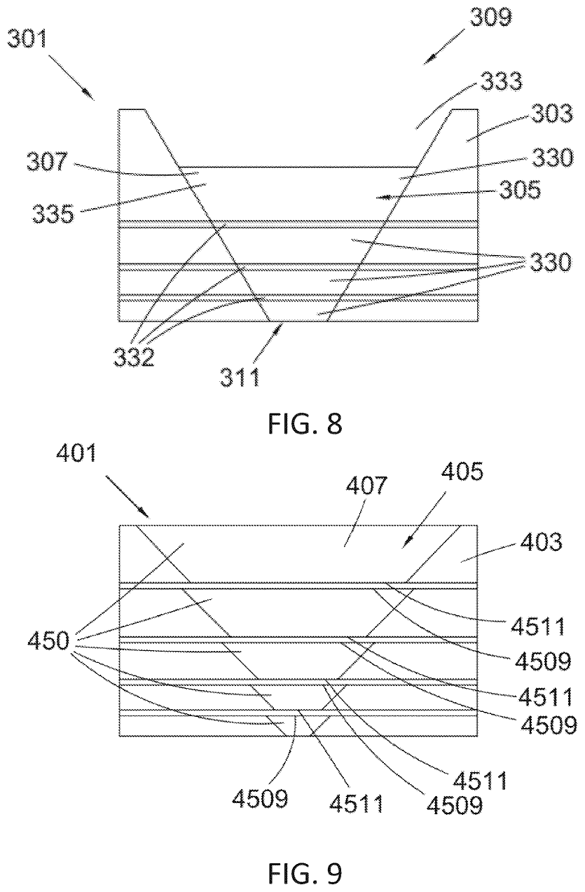

For example, it will be understood that not every sub-cavity 50 may be (e.g. fully) filled with a cavity fill material 7. For example, FIG. 8 shows a component 301 which is a variant of the component 1 of FIG. 2, wherein the sub-cavity 350 which forms the input layer 333 is unfilled. The first filled layer 335 in the cavity 305 is a low shock-impedance layer 330 because a first filled layer 335 formed from a high shock-impedance layer 332 would result in a larger portion of the shockwave being reflected by the first filled layer 335, and hence not transmitted into the rest of the component 301. The alternative is however envisaged, and a first filled layer 335 formed from a high shock-impedance layer 332 may help to better couple the shock into the component 301 since a high shock-impedance layer may have a more similar shock-impedance to that of a projectile 13 striking the component.

In the embodiment of FIG. 8, the impacting projectile 13 only strikes the body 303 of the component 301 directly. This may lead to the generation of an axially converging shock reflection within the projectile 13, which passes into the cavity fill material 307 when the front face of the projectile 13 contacts the first filled layer 335. These transmitted-reflected shocks subsequently superimpose on the central axis within the cavity 305, leading to the generation of a high pressure state that expands as a Mach stem towards the output 311. The function of the cavity 305 and the subsequent parallel layers 330, 332, is as described above in relation to FIG. 2.

In simulations, a component in line with the embodiment of FIG. 8 has achieved a pressure multiplication factor of 5, with an input shockwave having a pressure of 140 GPa, and an output shockwave having a pressure of 700 GPa.

FIG. 9 shows a further variant of the embodiment of FIG. 2 in which the cavity 405 has a different shape. The component 401 shown in FIG. 9 may also be manufactured using a method of manufacture in accordance with the present invention. As in the embodiment of FIG. 2, the body 403 is formed of a plurality of layers, each layer defining a frustum shaped sub-cavity 450 having an input 4509 and an output 4511. In the illustrated embodiment, each sub-cavity is a conical frustum, but other shapes are considered. In the embodiment of FIG. 9, the cross sectional area of the input 4509 of each sub-cavity 450 is greater than the cross sectional area of the output 4511 of the preceding sub-cavity. In conical frustum embodiments, this means that the radius of the input 4509 of each sub-cavity is greater than the radius of the output 4511 of the preceding sub-cavity.

The component 401 shown in FIG. 9 functions in substantially the same way as described above in relation to FIG. 2, but the overlapping outputs 4511 and inputs 4509 enables shocks that are transmitted from the cavity fill material 407 of a sub-cavity 450 into the body 403 of the component 401 to be partially recaptured by the input 4509 of the subsequent sub-cavity 450, and focussed back into the cavity fill material 407 contained in that sub-cavity. This may lead to a reduced amount of shock loss and hence a more efficient component 401. Further, since the sub-cavities 450 are discrete, the different sub-cavities 450 can have different properties such as input diameter, output diameter, thickness, material, and sub-cavity wall angle. It will be understood that although the thickness may vary between layers, each individual layer has a uniform thickness across its width.

In each of the embodiments described above, the diagrams shown are a vertical cross-section through a three-dimensional component and hence they depict embodiments that are rotationally symmetric. However, this is not essential to the invention.

It will be understood that the embodiments explicitly disclosed herein are intended to be exemplary, and the skilled person will understand that features of the embodiments disclosed herein may be combined in combinations not explicitly mentioned in order to form new embodiments.

1. A method of manufacturing a component for manipulating an input shockwave, the method comprising:
forming a plurality of plates, each plate defining a sub-cavity;
at least partially filling one or more of the sub-cavities with one or more cavity fill materials; and
stacking the plurality of plates to form a component, such that the sub-cavities are at least partially aligned and the sub-cavities combine to define a layered component cavity containing the one or more cavity fill materials.

2. A method as claimed in claim 1, wherein one or more of the plurality of plates are formed from a high density material.

3. A method as claimed in claim 1, wherein one or more of the plurality of plates are formed from metal.

4. A method as claimed in claim 1, wherein the or each cavity fill material has a lower density than one or more of the plurality of plates.

5. A method as claimed in claim 1, wherein filling one or more of the sub-cavities with one or more cavity fill materials comprises filling one or more sub-cavities with a pourable material.

6. A method as claimed in claim 5, further comprising curing the pourable material.

7. A method as claimed in claim 5, further comprising over-filling the one or more sub-cavities, and milling back the surfaces of the one or more of the plurality of plates.

8. A method as claimed in claim 1, wherein the component cavity comprises an input for receiving the shockwave, and an output for outputting the shockwave, and wherein the component cavity is shaped such that the cross sectional area of the input is greater than the cross sectional area of the output.

9. A method as claimed in claim 1, wherein each sub-cavity has an input for receiving the shockwave, and an output for outputting the shockwave, and wherein one or more of the sub-cavities is shaped such that the cross sectional area of the input is greater than the cross sectional area of the output.

10. A method as claimed in claim 9, wherein one or more of the sub-cavities is frustum shaped.

11. A method as claimed in claim 10, wherein one or more of the sub-cavities is a conic frustum.

12. A method as claimed in claim 1, wherein two or more of the plurality of plates comprise one or more holes configured to receive a fastening member, and wherein the method comprises securing the two or more plates together by placing one or more fastening members through the one or more holes.

13. A method as claimed in claim 1, wherein two or more of the plurality of plates comprise one or more alignment holes configured to receive an alignment member, and wherein the method comprises aligning the two or more plates together by placing one or more alignment members through the one or more alignment holes.

14. A method as claimed in claim 1, wherein the plurality of plates are a plurality of first plates, and the method comprises forming one or more second plates which do not comprise a sub-cavity, and stacking the second plates with the first plates.

15. A method as claimed in claim 14, wherein the method comprises stacking the plurality of first plates and the one or more second plates such that the plates alternate between first plates and second plates.

16. A method as claimed in claim 1, wherein the thickness of the first plates decreases progressively from the component cavity input to the component cavity output.

17. A method as claimed in claim 1, wherein the component is for manipulating an input shockwave to produce localized energy concentrations.

18. A method as claimed in claim 1, wherein stacking the plurality of plates to form a component is performed after at least partially filling one or more of the sub-cavities.

19. A method as claimed in claim 1, wherein each of the one or more sub-cavities is at least partially filled after the plate defining said sub-cavity has been formed.
